(19) United States
(12) Patent Application Publication
(10) Pub. No.: US 2003/0090558 A1
(43) Pub. Date: May 15, 2003

(54) Package for printhead chip

(76) Inventors: Anthony L. Coyle, Plano, TX (US); Margaret Simmons-Matthews, Richardson, TX (US)

Correspondence Address: TEXAS INSTRUMENTS INCORPORATED, P O BOX 655474, M/S 3999, DALLAS, TX, 75265

(21) Appl. No.: 10/104,254

(22) Filed: Mar. 22, 2002

Related U.S. Application Data
(60) Provisional application No. 60/334,884, filed on Nov. 15, 2001.

(51) Int. Cl. B41J 3/36

(52) U.S. Cl. 347/109

(57) ABSTRACT

A molded body (20) of a printhead chip package (70) for use in a hand-held apparatus is provided. The molded body (20) has a bottom surface (22) adapted to be attached to the hand-held apparatus. A fluid reservoir (24) is formed in a central region of the molded body (20), and is bounded on its sides (26) by the molded body (20). A bottom (28) of the fluid reservoir (24) is at least partially open. A recessed cavity (30) is formed in the central region of the molded body (20) above the fluid reservoir (24), and is bounded on its sides (32) by the molded body (20). A top (34) of the recessed cavity (30) is at least partially open. A first part of a bottom (36) of the recessed cavity (30) is bounded by the molded body (20). A second part of the bottom of the recessed cavity (30) is open to a top opening (40) of the fluid reservoir (24). The recessed cavity (30) is adapted to receive a printhead chip (72) therein.

### CROSS-REFERENCE TO RELATED APPLICATION

This application claims the priority benefit of commonly owned U.S. Provisional Patent Application having Serial No. 60/334,884 entitled LOW COST PACKAGE/HOLDER FOR LEXMARK PRINTHEAD filed on Nov. 15, 2001, which is hereby incorporated by reference.

### FIELD OF THE INVENTION

The present invention relates to packages for printhead chips for use in a hand-held apparatus.

### BACKGROUND

Inkjet printers have become prevalent and widely used for home and office computer systems. There are numerous ways of accurately and precisely expelling ink from printheads for inkjet printers, such as heated element printheads that cause the ink to be expelled by heating the ink and thereby increasing the pressure of the ink in a controlled manner, and such as mechanically pressurizing and/or vibrating the ink with a piezoelectric transducer. Such printheads are typically electronically controlled and driven by one or more processors to dispense and expel ink in precisely measured quantities with precise timing.

### BRIEF SUMMARY OF THE INVENTION

In accordance with one aspect of the present invention, a molded body of a printhead chip package for use in a hand-held apparatus is provided. The molded body includes a bottom surface, a fluid reservoir, and a recessed cavity. The bottom surface is adapted to be attached to a handle portion of the hand-held apparatus. The fluid reservoir is formed in a central region of the molded body. The fluid reservoir is bounded on its sides by the molded body. A bottom of the fluid reservoir is at least partially open. The recessed cavity is formed in the central region of the molded body above the fluid reservoir. The recessed cavity is bounded on its sides by the molded body. A top of the recessed cavity is at least partially open. A first part of a bottom of the recessed cavity is bounded by the molded body. A second part of the bottom of the recessed cavity is open to a top opening of the fluid reservoir. The recessed cavity is adapted to receive a printhead chip therein. A step feature may be formed on the first part of the bottom of the recessed cavity. The recessed cavity also may be adapted to receive a nozzle chip therein, wherein the nozzle chip is attached onto the printhead chip. The molded body may be formed from a non-conductive material, such as plastic. The molded body may further comprise a plurality of holes formed through the molded body and extending from an upper end of the molded body through the bottom surface of the molded body, wherein each of the plurality of holes is adapted to receive an electrically conductive pin therein. The plurality of electrically conductive pins may be installed in the plurality of holes formed in the molded body during the manufacturing of the molded body or they may be installed later while assembling the package that the molded body is used in. In alternative to pins, the molded body may further comprise a leadframe embedded in the molded body, the lead frame having a first connection end extending to the recessed cavity, the lead frame having a second connection end extending to at least one of, the bottom surface of the molded body and sides of the molded body. The recessed cavity of the molded body may have a width of about 3.2 mm, a length between about 7.2 mm and about 7.6 mm, and a depth between about 0.50 mm and about 0.65 mm.

In accordance with another aspect of the present invention, a package for a printhead chip for use in a hand-held apparatus is provided. The package includes a molded body having a bottom surface adapted to be attached to a handle portion of the hand-held apparatus. A fluid reservoir is formed in a central region of the molded body. The fluid reservoir is bounded on its sides by the molded body. A bottom of the fluid reservoir being open. A recessed cavity is formed in the central region of the molded body above the fluid reservoir. The recessed cavity is bounded on its sides by the molded body. A top of the recessed cavity is open. A first part of a bottom of the recessed cavity is bounded by the molded body, and a second part of the bottom of the recessed cavity is open to the top of the fluid reservoir, wherein the top of the fluid reservoir is open to the recessed cavity. The recessed cavity is adapted to receive a printhead chip therein. A plurality of holes are formed through the molded body and extend from an upper end of the molded body through the bottom surface of the molded body. Each of the plurality of holes is adapted to receive an electrically conductive pin therein. A step feature may be formed on the first part of the bottom of the recessed cavity. The recessed cavity also may be adapted to receive a nozzle chip therein, wherein the nozzle chip is attached onto the printhead chip. The molded body may be formed from a non-conductive material, such as plastic. The recessed cavity also may be adapted to be filled with potting compound after the printhead chip is installed and after providing an electrical connection between the printhead chip and the pins.

In accordance with yet another aspect of the present invention, a package for a printhead chip for use in a hand-held apparatus is provided. The package includes a molded body having a bottom surface adapted to be attached to a handle portion of the hand-held apparatus. A fluid reservoir is formed in a central region of the molded body. The fluid reservoir is bounded on its sides by the molded body. A bottom of the fluid reservoir being open. A recessed cavity is formed in the central region of the molded body above the fluid reservoir. The recessed cavity is bounded on its sides by the molded body. A top of the recessed cavity is open. A first part of a bottom of the recessed cavity is bounded by the molded body, and a second part of the bottom of the recessed cavity is open to the top of the fluid reservoir, wherein the top of the fluid reservoir is open to the recessed cavity. The recessed cavity is adapted to receive a printhead chip therein. A leadframe is embedded in the molded body. The lead frame has a first connection end extending to the recessed cavity, and a second connection end extending to at least one of, the bottom surface of the molded body and sides of the molded body. A step feature may be formed on the first part of the bottom of the recessed cavity. The second connection end of the lead frame may extend to and through one of the sides of the molded body and/or the bottom surface of the molded body. The recessed cavity also may be adapted to be filled with potting compound after the printhead chip is installed and after providing an electrical connection between the printhead chip and the first connection end of the leadframe.

### BRIEF DESCRIPTION OF THE DRAWINGS

Other objects and advantages of the invention will become apparent upon reading the following detailed description and upon referencing the accompanying drawings, in which:

FIG. 1 is a top view of a molded body in accordance with a first embodiment of the present invention;

FIG. 2 is a cut-away section view of FIG. 1;

FIG. 3 is a top view of a molded body in accordance with a second embodiment of the present invention;

FIG. 4 is a cut-away section view of FIG. 3;

FIG. 5 is a top view of a molded body in accordance with a third embodiment of the present invention;

FIG. 6 is a cut-away section view of FIG. 5;

FIG. 7 is a top view of a package in accordance with a fourth embodiment of the present invention;

FIG. 8 is a cut-away section view of FIG. 7; and

FIG. 9 is a cut-away section view of a package in accordance with a fifth embodiment of the present invention.

### DETAILED DESCRIPTION OF THE INVENTION

Referring now to the drawings, wherein like reference numbers are used herein to designate like elements throughout the various views, preferred embodiments of the present invention are illustrated and described. The figures are not necessarily drawn to scale, and in some instances the drawings may be exaggerated and/or simplified in places for illustrative purposes only. One of ordinary skill in the art will appreciate the many possible applications and variations of the present invention based on the following examples of possible embodiments of the present invention.

Electrically driven printheads have been widely used for inkjet printer applications. As the technology of inkjet printers has progressed, the inkjet printers have become more advanced (e.g., higher resolution, faster print time) as well as less expensive. With these advances, many of the printheads for such printers have become smaller and more power efficient, as well as less expensive and more precise. With the printheads available today, it now possible to apply these printheads to other applications, other than inkjet printers. For example, one company is currently developing a hand-held apparatus having a printhead attached to its tip for expelling fluid for a variety of possible uses, such as an electrically driven paint or ink brush that can be used much like an airbrush. Other possible uses may be a nasal spray dispenser or a medicine dispenser, for example. Hence, a small printhead (e.g., about 3 mm by about 7 mm) normally used for an inkjet printer may be incorporated into some kind of hand-held, battery-operated, portable fluid expelling apparatus, which may have a wide range of uses (not just ink dispensing). However, to use an existing printhead for such a hand-held apparatus, a package or holder for the printhead is needed for attaching the printhead to the hand-held apparatus. Existing inkjet printer cartridges may not suffice because they are typically specially designed to fit within a particular printer model. Also, the contacts for a typical inkjet printer cartridge usually have tape automated bonding (TAB) type bonding on a tape substrate, which is less preferred for a portable or hand-held application.

An embodiment of the present invention provides a package for a printhead chip for use in a hand-held apparatus. Such a package comprises a molded body having a bottom surface and bottom shape that are adapted to be attached to a handle portion of the hand-held apparatus. Such a hand-held apparatus may or may not be battery operated. Also, the molded body is adapted to house functional components, such as the printhead chip, a nozzle chip, a fluid reservoir, electrical connectors, potting compound, and wire bonds, for example.

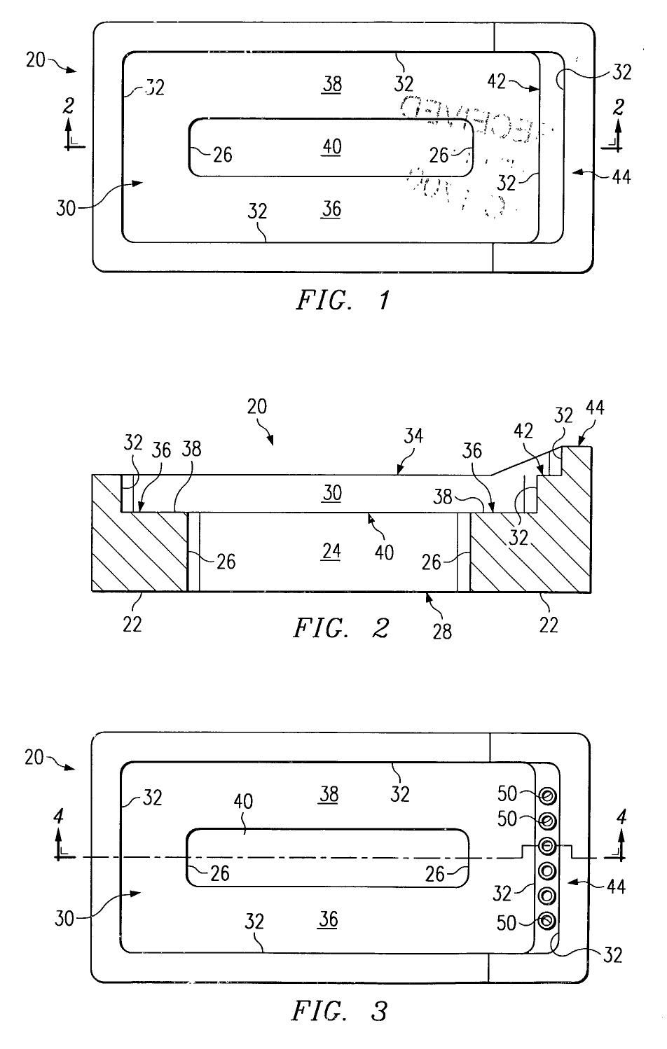

FIG. 1 is a top view of a molded body 20 for a package of a first embodiment of the present invention. FIG. 2 is a cut-away section view of FIG. 1 taken along line 2-2. The dimensions shown in FIGS. 1 and 2 are in millimeters. The dimensions of the first embodiment are shown in FIGS. 1 and 2 by way of example to illustrate the size of the first embodiment. The dimensions may vary for other embodiments and other applications of the present invention.

The molded body 20 may be formed from a non-conductive material, such as plastic. An advantage of the molded body 20 is that it may be formed using the same techniques and materials commonly used for making test sockets, which a manufacturer or assembler may already have equipment for. The molded body may also be made from the same material used to make inkjet printer cartridges, which a manufacturer or assembler may already have equipment and facilities set up for. Furthermore, using the same materials as used for test sockets or inkjet printer cartridges, a polymer, and/or plastic, for example, may allow the molded body 20 to be low cost, durable, sterile, and/or resistant to corrosion for a variety of fluids (e.g., ink, paint, chemicals, medicine) and uses.

Referring to FIGS. 1 and 2, the molded body 20 has a bottom surface 22 that is adapted to be attached to a handle-portion (not shown) of a hand-held apparatus (not shown) by some kind of adhesion or bonding, such as epoxy. However, in other embodiments (not shown), the bottom surface 22 may have tabs with screw holes formed therethrough, for example, to allow the molded body 20 to be removably attached to a hand-held apparatus with screws.

A fluid reservoir 24 is formed in a central region of the molded body 20. The fluid reservoir 24 is bounded on its sides 26 by the molded body 20, but the bottom 28 of the fluid reservoir 24 is open in the first embodiment. Because the molded body 20 is adapted to be attached to a hand-held apparatus (not shown), the bottom 28 of the fluid reservoir 24 will likely be fluidly coupled to a larger fluid supply of the hand-held apparatus. In other embodiments (not shown) however, the bottom 28 of the fluid reservoir 24 may be partially covered by a bottom surface with a fluid channel formed therein. Hence, the bottom 28 of the fluid reservoir 24, as well as the bottom surface 22 of the molded body 20, will depend on the corresponding portion of the hand-held apparatus to which the molded body 20 is adapted to mate with when the molded body 20 is attached to the hand-held apparatus.

Still referring to FIGS. 1 and 2, a recessed cavity 30 is formed in the central region of the molded body 20 above the fluid reservoir 24. The sides 32 of the recessed cavity 30 are bounded by the molded body 20. The top 34 of the recessed cavity 30 of the first embodiment is open, but in other embodiments (not shown) the top 34 of the recessed cavity 30 may be only partially open. A first part 36 of the bottom of the recessed cavity 30 is bounded by the molded body 20, which provides a surface 38 for adhering the printhead chip (not shown in FIGS. 1 and 2) to the molded body 20 within the recessed cavity 30. A second part 40 of the bottom of the recessed cavity 30 is open to the top 40 of the fluid reservoir 24. Hence, the recessed cavity 30 is fluidly coupled to the fluid reservoir 24. As shown in other figures herein and discussed further below, the printhead chip will typically cover at least a portion of the opening 40 fluidly connecting the recessed cavity 30 to the fluid reservoir 24 because the printhead chip will very likely have holes or fluid channels for controllably drawing fluid from the fluid reservoir and pressurizing the fluid for expelling it from the hand-held apparatus. Thus, the dimensions and configuration of the recessed cavity 30 will typically depend on the dimensions and configuration of the printhead chip for which the recessed cavity 30 is adapted to receive therein.

In the first embodiment, the recessed cavity 30 has a step feature 42 formed in the first part 36 of its bottom surface 38. As discussed further below, this step feature 42 provides a second level of the bottom 36 of the recessed cavity 30 for placement of terminals (not shown in FIGS. 1 and 2). In the first embodiment, the sides 32 bounding the recessed cavity 30 also have a raised portion 44 adjacent to the step feature 42. Hence, one end of the molded body 20 is taller than the other end in the first embodiment, as best shown in FIG. 2. This raised portion 44 provides an extension of the recessed cavity 30 to provide space for containing potting compound (not shown) that will later cover and protect terminals and wire bonds (not shown in FIGS. 1 and 2). The first embodiment shown in FIGS. 1 and 2 is without terminal leads or pins because the molded body 20 may be supplied without terminal leads or pins. For example, an assembler may purchase the molded body 20, as shown in FIGS. 1 and 2, and use it in a package that the assembler will complete with other components.

FIGS. 3 and 4 show a second embodiment of the present invention. The dimensions shown in FIGS. 3 and 4 are in millimeters. The dimensions of the second embodiment are shown in FIGS. 3 and 4 by way of example to illustrate the size of the second embodiment. The dimensions may vary for other embodiments and other applications of the present invention.

The second embodiment is the same as the first embodiment, but with the addition of terminal pins 50. To make the second embodiment, a molded body 20 without pin holes, such as the first embodiment of FIGS. 1 and 2, may have holes 52 drilled therethrough. Then, the terminal pins 50 can be pressed into the holes 52 to form the second embodiment, as shown in FIGS. 3 and 4. Such assembly is commonly done for test sockets, for example, and thus the manufacturer or assembler may already have equipment capable of drilling the holes 52 and inserting the terminal pins 50. In alternative, the holes 52 for the terminal pins 50 may be formed in the molded body 20 during the molding of the molded body 20, so that the holes 52 for the terminal pins 50 are preformed (i.e., no hole drilling needed).

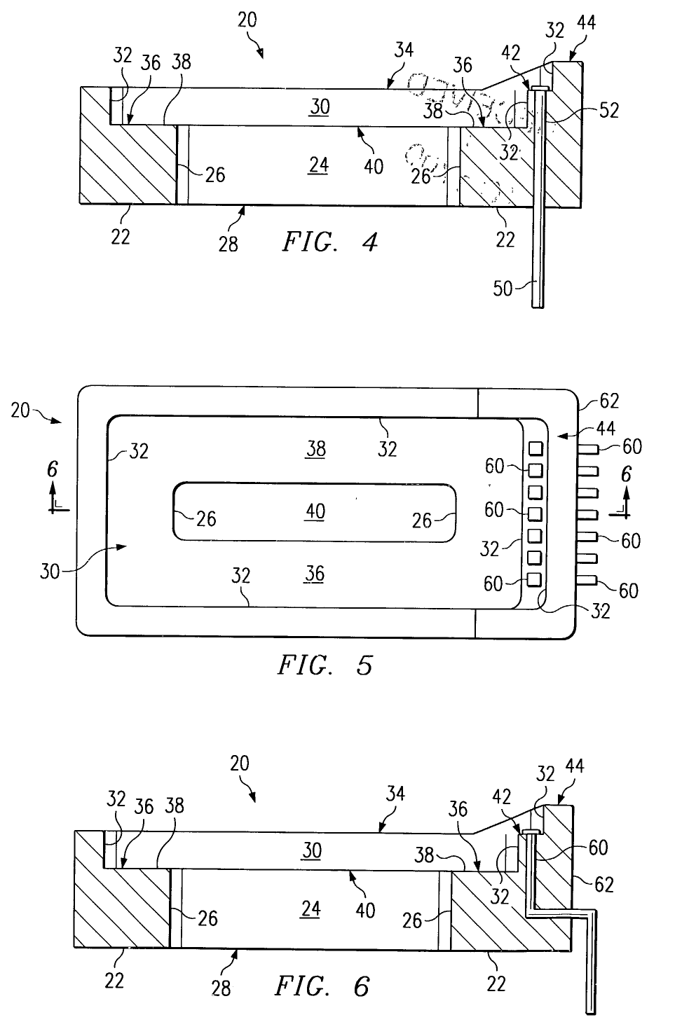

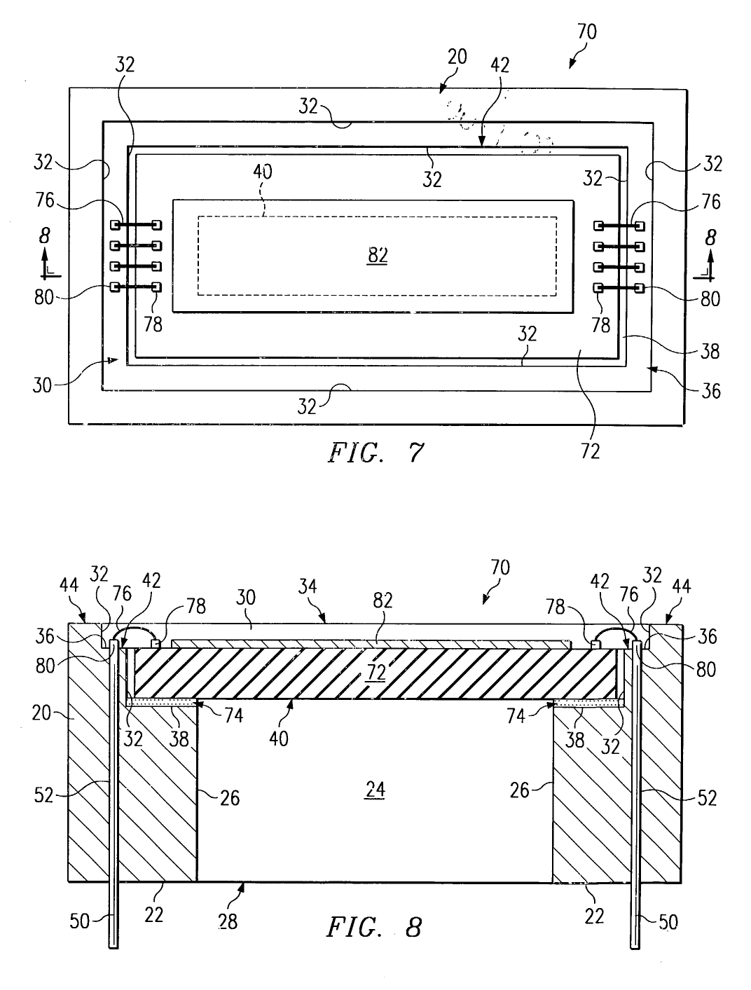

FIGS. 5 and 6 show a third embodiment of the present invention. The dimensions shown in FIGS. 5 and 6 are in millimeters. The dimensions of the third embodiment are shown in FIGS. 5 and 6 by way of example to illustrate the size of the third embodiment. The dimensions may vary for other embodiments and other applications of the present invention.

The third embodiment is the same as the first embodiment, but with the addition of a leads 60 of a lead frame embedded in the molded body 20. Hence, the lead frame 60 may be installed within the mold before an injection mold process to form the molded body 20. The lead frame 60 may have a variety of shapes and configurations. In the third embodiment, the leads 60 extends from one side 62 of the molded body 20, as best shown in the section view of FIG. 6. In alternative, or in addition, the lead frame may have leads 60 extending from the bottom surface 22 of the molded body 20 (not shown). The use of a lead frame 60 rather than terminal pins 50 provides the advantage of more design flexibility for the shape and configuration of the terminal leads 60. However, the lead frame design (FIGS. 5 and 6) will likely be more expensive to produce than the terminal pin design (FIGS. 3 and 4).

FIGS. 7 and 8 show a package 70 in accordance with a fourth embodiment of the present invention. In the package 70 of the fourth embodiment, there is a printhead chip 72 installed within the recessed cavity 30 of the molded body 20. Some type of adhesive 74, such as an epoxy, is used to adhere the printhead chip 72 to the molded body 20 and to provide a seal for the fluid reservoir 24 below. Wire bonds 76 connect between bond pads 78 on the printhead chip 72 and the terminals 80 of the terminal pins 50. However, other ways of providing such an electrical connection may by used, such as flat lead bonds (not shown) or welding (not shown), for example. Also, a nozzle chip 82 is attached onto the printhead chip 72. However, in other embodiments (not shown), the nozzle chip 82 and printhead chip 72 may be a single component rather than two separate components. Fluid channels (not shown) are formed in the printhead chip 72, which are fluidly coupled to the fluid reservoir 24. Orifices (not shown) are formed in the nozzle chip 82, which are fluidly coupled to the fluid channels of the printhead chip 72. Hence, the passage of fluid from the fluid reservoir 24 through the printhead chip 72 and out of the nozzle chip 82 is electrically controlled and driven by the printhead chip 72. As a result, fluid may be expelled from the package 70 in a precisely metered and controlled manner according to the needs of a given application. The fourth embodiment of FIGS. 7 and 8 also illustrates that there may be terminal pins 50 on more than one side of the package 70. In the fourth embodiment the terminal pins 50 are on two sides. For other embodiments (not shown) however, there may be more (or less) terminal pins 50 on one or more sides (in any combination of the sides) for forming other configurations. Typically the layout, configuration, and number of terminal pins 50 will depend on the bond pads 78 on the printhead chip 72 and/or the contacts (not shown) on the hand-held apparatus (not shown) that the package 70 is adapted to work with and attach to.

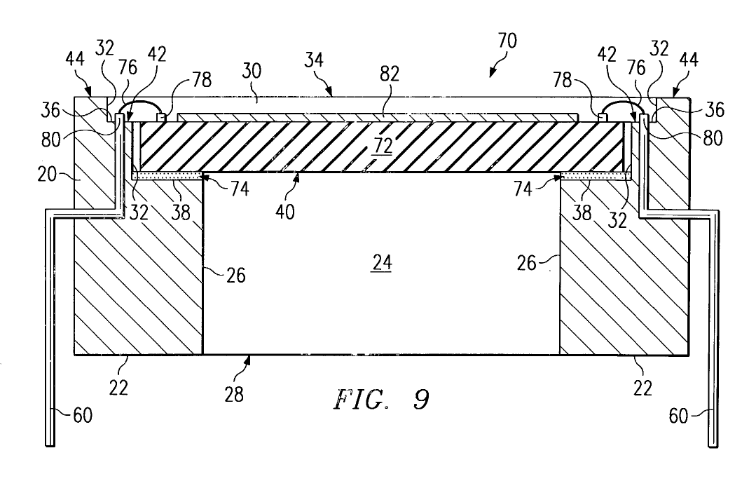

FIG. 9 shows a package 70 in accordance with a fifth embodiment of the present invention. FIG. 9 is a cut-away section view of the package 70, which is similar to the package 70 shown in FIGS. 7 and 8, but the fifth embodiment incorporates a lead frame design rather than terminal pins 50, as in the fourth embodiment. FIG. 9 illustrates that there may be leads 60 on more than one side of the package 70. In the fifth embodiment the leads 60 are on two sides. For other embodiments (not shown) however, there may be more (or less) leads 60 on one ore more sides (in any combination of the sides) for forming other configurations. Typically the layout, configuration, and number of leads 60 will depend on the bond pads 78 on the printhead chip 72 and/or the contacts (not shown) on the hand-held apparatus (not shown) that the package 70 is adapted to work with and attach to.

Although in the embodiments shown in FIGS. 1-9 each has only a single fluid reservoir 24, for other embodiments (not shown) there may be numerous fluid reservoirs formed within the molded body 20. For example, if an embodiment is adapted for use with a multicolor printhead chip (not shown) for expelling inks of various color combinations, there may be a separate fluid reservoir for each primary color expelled. Also, an embodiment (not shown) may have a plurality of recessed cavities for receiving a plurality of printhead chips.

It will be appreciated by those skilled in the art having the benefit of this disclosure that an embodiment of the present invention provides a package with a molded body for containing, among other things, a printhead chip for a hand-held apparatus. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. A molded body of a printhead chip package for use in a hand-held apparatus, comprising:
a bottom surface adapted to be attached to the hand-held apparatus;
a fluid reservoir formed in a central region of the molded body, the fluid reservoir being bounded on its sides by the molded body, a bottom of the fluid reservoir being at least partially open; and
a recessed cavity formed in the central region of the molded body above the fluid reservoir, the recessed cavity being bounded on its sides by the molded body, a top of the recessed cavity being at least partially open, a first part of a bottom of the recessed cavity being bounded by the molded body, a second part of the bottom of the recessed cavity being open to a top opening of the fluid reservoir, and the recessed cavity being adapted to receive a printhead chip therein.

2. The molded body of claim 1, further comprising:
a step feature formed on the first part of the bottom of the recessed cavity.

3. The molded body of claim 1, wherein the recessed cavity is also adapted to receive a nozzle chip therein, wherein the nozzle chip is attached onto the printhead chip.

4. The molded body of claim 1, wherein the molded body is formed from a non-conductive material.

5. The molded body of claim 4, wherein the molded body comprises plastic.

6. The molded body of claim 1, further comprising:
a plurality of holes formed through the molded body and extending from an upper end of the molded body through the bottom surface of the molded body, each of the plurality of holes being adapted to receive an electrically conductive pin therein.

7. The molded body of claim 6, wherein the plurality of electrically conductive pins are installed in the plurality of holes formed in the molded body.

8. The molded body of claim 1, further comprising:
a leadframe embedded in the molded body, the lead frame having a first connection end extending to the recessed cavity, the lead frame having a second connection end extending to at least one of, the bottom surface of the molded body and sides of the molded body.

9. The molded body of claim 1,
wherein the recessed cavity has a width of about 3.2 mm, a length between about 7.2 mm and about 7.6 mm, and a depth between about 0.50 mm and about 0.65 mm.

10. The molded body of claim 1 in combination with the printhead chip, the printhead chip being secured in the recessed cavity.

11. A package for a printhead chip for use in a hand-held apparatus, comprising:
a molded body having a bottom surface adapted to be attached to a handle portion of the hand-held apparatus;
a fluid reservoir formed in a central region of the molded body, the fluid reservoir being bounded on its sides by the molded body, a bottom of the fluid reservoir being open;
a recessed cavity formed in the central region of the molded body above the fluid reservoir, the recessed cavity being bounded on its sides by the molded body, a top of the recessed cavity being open, a first part of a bottom of the recessed cavity being bounded by the molded body, a second part of the bottom of the recessed cavity being open to a top of the fluid reservoir, wherein the top of the fluid reservoir is open to the recessed cavity, and the recessed cavity being adapted to receive the printhead chip therein; and
a plurality of holes being formed through the molded body and extending from an upper end of the molded body through the bottom surface of the molded body, each of the plurality of holes being adapted to receive an electrically conductive pin therein.

12. The package of claim 11, further comprising:
a step feature formed on the first part of the bottom of the recessed cavity.

13. The package of claim 11, wherein the recessed cavity is also adapted to receive a nozzle chip therein, wherein the nozzle chip is attached onto the printhead chip.

14. The package of claim 11, wherein the molded body is formed from a non-conductive material.

15. The package of claim 14, wherein the molded body comprises plastic.

16. The package of claim 11, further comprising:
the printhead chip secured within the recessed cavity.

17. The package of claim 16, wherein the electrically conductive pins are installed in the holes.

18. The package of claim 17, wherein the recessed cavity is also adapted to be filled with potting compound after the printhead chip is installed and after providing an electrical connection between the printhead chip and the pins.

19. A package for a printhead chip for use in a hand-held apparatus, comprising:
a molded body having a bottom surface adapted to be attached to a handle portion of the hand-held apparatus;
a fluid reservoir formed in a central region of the molded body, the fluid reservoir being bounded on its sides by the molded body, a bottom of the fluid reservoir being open;
a recessed cavity formed in the central region of the molded body above the fluid reservoir, the recessed cavity being bounded on its sides by the molded body, a top of the recessed cavity being open, a first part of a bottom of the recessed cavity being bounded by the molded body, a second part of the bottom of the recessed cavity being open to a top of the fluid reservoir, wherein the top of the fluid reservoir is open to the recessed cavity, and the recessed cavity being adapted to receive the printhead chip therein; and
a leadframe embedded in the molded body, the lead frame having a first connection end extending to the recessed cavity, the lead frame having a second connection end extending to at least one of, the bottom surface of the molded body and sides of the molded body.

20. The package of claim 19, further comprising:
a step feature formed on the first part of the bottom of the recessed cavity.

21. The package of claim 19, wherein the second connection end of the lead frame extends to and through at least one of the sides of the molded body.

22. The package of claim 19, wherein the second connection end of the lead frame extends to and through the bottom surface of the molded body.

23. The package of claim 19, further comprising:
the printhead chip secured within the recessed cavity.

24. The package of claim 23, wherein the recessed cavity is also adapted to be filled with potting compound after the printhead chip is installed and after providing an electrical connection between the printhead chip and the first connection end of the leadframe.
